(19) United States
(12) Patent Application Publication
(10) Pub. No.: US 2004/0138408 A1
(43) Pub. Date: Jul. 15, 2004

(54) Polymide lcd alignment layer

(76) Inventors: Frank W. Harris, Akron, OH (US); Stephen Z Cheng, Hudson, OH (US)

Correspondence Address: George W Moxon II, Roetzel & Andress, 222 South Main Street, Akron, OH, 44308, US

(21) Appl. No.: 10/250,828

(22) PCT Filed: Jan. 2, 2002
(86) PCT No.: PCT/US02/00058

(51) Int. Cl. C08G 69/08; C08G 73/10; C08G 63/08

(52) U.S. Cl. 528/354; 428/543

(57) ABSTRACT

A polyimide comprises a reaction product of at least one dianhydride and at least one diamine, wherein the at least one diamine contains a pendent mesogenic group. A method for inducing a predetermined orientation of a liquid crystal material is also disclosed. The method includes applying an alignment layer material to a substrate and buffing the alignment layer material, thereby providing an alignment layer with a pre-tilt angle, wherein the alignment layer material is a reaction product of at least one dianhydride and at least one diamine, wherein the at least one diamine contains a pendent mesogenic group.

### CROSS REFERENCE TO RELATED APPLICATIONS

This application claims benefit of pending U.S. Provisional Application Nos. 60/259,162 and 60/259,235, both filed on Jan. 2, 2001.

### BACKGROUND OF THE INVENTION

Liquid Crystal Displays (LCD) are currently used for a variety of display applications, such as watch faces, calculators, computer screens and other types of electronic equipment. LCD technology offers widely known advantages over traditional display technologies such as cathode ray tubes. Among these advantages are low weight and low power consumption.

Liquid crystal displays, however, have previously been considered to provide a narrower field of view than traditional display technologies, such as the previously mentioned cathode ray tubes.

Liquid crystal displays typically contain a plurality of liquid crystal cells. Each liquid crystal cell generally contains a liquid crystal material sandwiched between two substrates. Located on either side of the liquid crystal material is a set of electrodes which are typically indium-tin oxide (ITO) or tin oxide. A pair of polarizing filters is located outside of the substrates, with each filter on an opposite side of the liquid crystal cell. The polarizers are oriented at right angles relative to each other. The orientation of the liquid crystal material in the cell determines whether light passes through each polarizer in the absence of external influence such as an electric field, thereby giving a transparent appearance, or whether light is blocked by one of the polarizers, thereby giving the cell a darkened appearance. The orientation of the liquid crystal material is changed by the application of an electric field by the electrodes to alter light transmission through the cell. Typically, the liquid crystal material is aligned such that the cell appears opaque or transparent absent an application of an electric field through the electrodes. When an electric field is applied to such a cell, the orientation of the liquid crystal material is altered in such a way as to prevent the transmission of light through the cell, making the cell appear darkened.

The orientation of a liquid crystal material at its surface is dependent on the orientation of material it comes in contact with. It is known to coat the surface of a substrate with an agent which influences the orientation of a liquid crystal material that comes in contact with the coated substrate. Such coating agents are known as alignment layers. Various materials and methods have been used in establishing an alignment layer of a desired orientation. For example, it is known in the art that an alignment layer may comprise anisotropically absorbing molecules which can be oriented by exposure to polarized light. Inorganic thin films, such as metal oxide films, which have been deposited on a substrate at an oblique angle can also be used as alignment layers as disclosed in U.S. Pat. No. 5,638,197.

It is also known to use a polymeric alignment layer which can be oriented by means of a mechanical buffing process. In such a process, a polymer layer is applied to a substrate and is buffed with a cloth or other fibrous material. Liquid crystal material coming into contact with a surface treated in this way typically aligns itself parallel to the direction of buffing.

Polyimides are frequently used as a polymeric alignment material for liquid crystal cells and for optical compensator layers including O-plate compensators. Polyimides generally display good chemical stability and are easily deposited on a substrate and rubbed. Polyimides are generally prepared by contacting a diamine with an acid anhydride, producing a polyamic acid. This polyamic acid may be coated onto a substrate and heat treated at about 150°-230° C., converting the polyamic acid to a polyimide. The polyimide film is then mechanically rubbed as mentioned above.

Inducing the proper orientation of liquid crystal material is important in optical compensators. As mentioned above, LCDs frequently have a narrow field of view. It is frequently desirable to increase this field of view especially in applications such as computer displays, avionic displays and televisions. The viewing zone of an LCD that is not equipped with an optical compensator is narrow because light leaks through the liquid crystal material when viewed at angles other than those close to normal relative to the surface of the liquid crystal. Such light leakage degrades the image quality and can also cause color shifts in color LCDs. Optical compensators have been used to increase the viewable angle of LCDs without negatively affecting image quality when viewed normal to the surface of the LCD. Optical compensators typically take the form of an additional layer of liquid crystal material located between a polarizer and the viewing area, on the outer surface of an LCD. This liquid crystal material may be given a specific orientation under the influence of an alignment layer material.

O-plate compensation films, or O-plate compensators, are one type of optical compensator. O-plate compensators generally minimize reversal of gray levels and improve overall gray scale stability. O-plate compensators have been previously described as comprising a positive birefringent material which has a principle optic axis oriented at an oblique angle relative to the surface of the liquid crystal layer. An oblique angle includes any angle between 0° and 90°. In previous O-plate compensators, this angle has been provided in various ways. For example, U.S. Pat. No. 5,619,352 describes an O-plate compensator which includes an alignment layer, a liquid crystal pretilt layer, and a liquid crystal compensator layer. The described O-plate compensator depends on the liquid crystal pre-tilt layer to provide an adequate pre-tilt angle for the liquid crystal compensator layer because the alignment layer produces only a 1° to 10° liquid crystal pretilt angle at the alignment layer/liquid crystal pre-tilt layer interface. The described O-plate compensator therefore depends on multiple layers of liquid crystal material to provide an adequate angle of orientation of the liquid crystal material. A similar O-plate compensator is also described in U.S. Pat. No. 5,986,734 and PCT Application No. WO 96/10770. The use of high pre-tilt alignment layers is also known in LCDs known as pi-cells.

It should be appreciated that the term “pre-tilt angle” has frequently been used in the prior art to describe a final angle provided by a combination of an alignment layer and a liquid crystal layer. Heretofore, no single polyimide alignment layer for a liquid crystal layer has provided a pre-tilt angle greater than about 15°.

Therefore, there is a need for a polyimide alignment layer material which can provide a high, uniform pre-tilt angle.

### SUMMARY OF THE INVENTION

In general, the present invention provides a polyimide comprising a reaction product of at least one dianhydride and at least one diamine, wherein the at least one diamine contains a mesogenic group, with the proviso that when the at least one dianhydride is 2,2′-bis-(3,4-dicarboxyphenyl)-1,1,1,3,3,3-hexafluoropropane dianhydride (6FDA) or dibromo-biphenyltetracarboxylic dianhydride, the at least one diamine is not

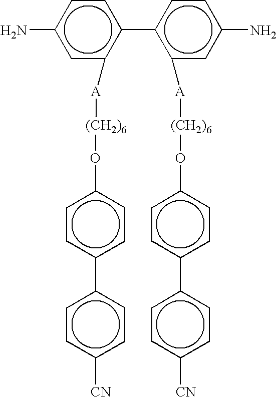

wherein A is selected from the group consisting of O and COO.

The present invention also provides a method for inducing a predetermined orientation of a liquid crystal material, the method comprising applying an alignment layer material to a substrate, and buffing the alignment layer material, thereby providing an alignment layer with a pre-tilt angle, wherein the alignment layer material is a reaction product of at least one dianhydride and at least one diamine, and wherein the at least one diamine contains a pendent mesogenic group.

### BRIEF DESCRIPTION OF THE SEVERAL VIEWS OF THE DRAWINGS

FIG. 1 is a schematic summary of a method of preparing a mesogenic group of the present invention.

FIG. 2 is a graph showing the pre-tilt angles of the, polyimides 6FDA/C6CN and 6FDA/C6CN (ether) after heat treatment at various temperatures.

FIG. 3 is a graph showing the pre-tilt angles of the polyimides 6FDA/C6CN and 6FDA/C6BP after heat treatment at various temperatures.

FIG. 4 is a graph showing the pre-tilt angles of the polyimides 6FDA/C6CN and 6FDA/C11CN after heat treatment at various temperatures.

FIG. 5 is a graph showing the pre-tilt angles of polyimides containing varying amounts of diamines with mesogenic pendent groups (C6BP) and diamines with perfluorinated carbon pendent groups (PFMB).

### DETAILED DESCRIPTION OF THE INVENTION

The present invention is directed toward polyimides which can be used to prepare liquid crystal display alignment layers for a liquid crystal device, such as an optical compensator, for example. The polyimides of the present invention contain mesogenic substituents and may optionally include functional substituents. Polyimides may be schematically represented by the structure

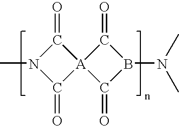

wherein A is one or more residues from an acid dianhydride group and B is one or more residues from a diamine compound and n is a positive number. It has been known that the properties of the polyimide may be altered by varying the components “A” and “B” as listed above. However, the use of polyimides containing mesogenic substituents to prepare high pre-tilt alignment layers has not been previously known. In the present invention, mesogenic groups are contributed to the structure of a polyimide by the diamine component. Any acid dianhydride useful in the synthesis of polyimides may be utilized in the present invention. Such acid dianhydrides are commercially available.

As mentioned above, polyimide polymers are prepared from diamines containing pendent mesogenic groups. In one particular example, the diamine contains a backbone portion, a methylene spacer, a linking group, and a pendent mesogenic group. The pendent mesogenic group is attached to the methylene spacer, the methylene spacer is attached to the linking group, and the linking group is attached to the backbone portion. The linking group is selected from the group consisting of an ester and an ether. In another embodiment, suitable diamines are represented by formulas I and II below.

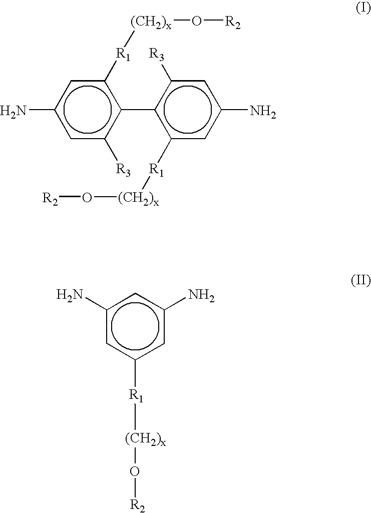

In formulas I and II, R₁ is an ester or ether linking group, R₂ is a mesogenic group or a functional group as defined below, and x is a positive number. In formula I, R₃ is hydrogen or a halogen. In one embodiment, x is between 6 and 18. In another example, x is between 6 and 11. In one particular example, x is 6. In another example, R₃ is bromine.

Mesogenic groups are groups with a rod-like molecular structure. That is, mesogenic groups, or simply mesogens, are groups with a length to width ratio of at least 5:1. Functional groups are those groups which allow one polyimide molecule to react with another molecule. Among preferred functional groups are groups which permit the crosslinking of polyimide molecules within a layer. Especially preferred functional groups include molecules which allow the photopolymerization of polyimide molecules, such as acrylate and methacrylate groups. Suitable diamines include those containing a substituent selected from the group of compounds containing one or more of the subunits represented by formulas III, IV, V, and VI.

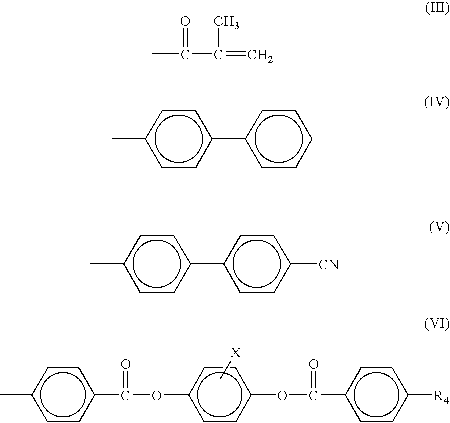

In formula VI, X may be hydrogen or an organic group having from 1 to 20 carbon atoms, and R₄ may be an organic group selected from the group consisting of esters, ethers, groups containing a methylene subunit, groups containing a crosslinking subunit and groups containing a combination of any of these subunits. Groups containing acrylate or methacrylate subunits may be crosslinked such as by photopolymerization, for example. In one example, X is an organic group containing between 1 and 16 carbon atoms. In another example, X is an organic group containing between 1 and 12 carbon atoms. In still another example, X is a methyl group. In yet another example, when the at least one dianhydride is 2,2′-bis-(3,4-dicarboxyphenyl)-1,1,1,3,3,3-hexafluoropropane dianhydride or dibromo-biphenyltetracarboxylic dianhydride, the substituent is not represented by formula V.

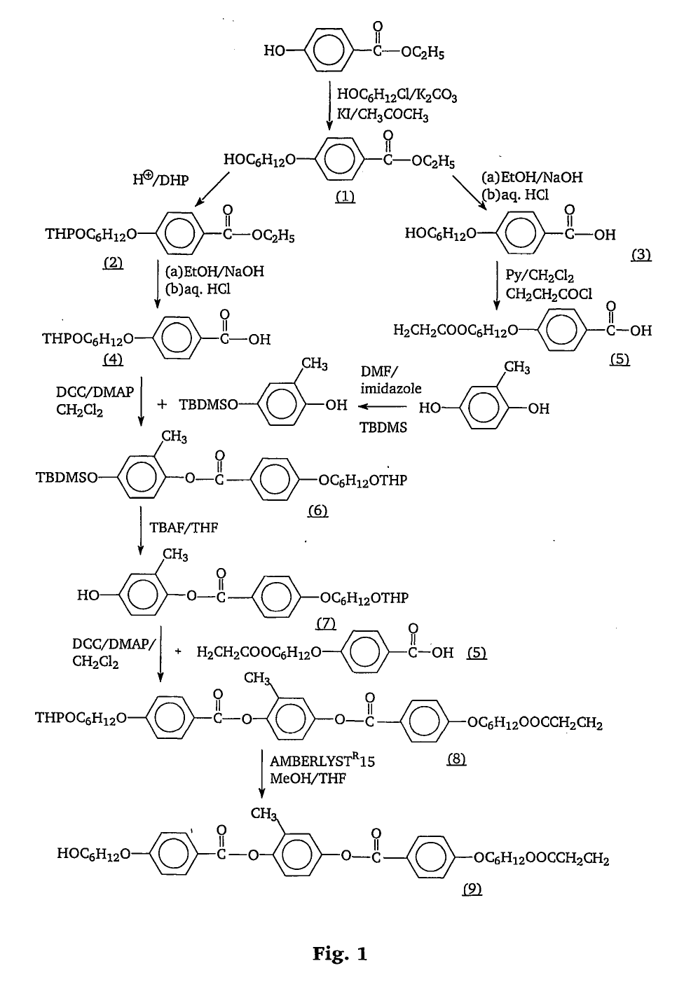

By way of example and not of limitation, a mesogenic group shown in VI may be synthesized by the following method as described below with reference to FIG. 1. Ethyl 4-hydroxybenzoic ester is alkylated with 6-chlorohexanol to produce intermediate (1). Intermediate (1) was used in two different reactions. In the first reaction, the hydroxyl group of intermediate (1) was protected using 3,4-dihydro-2-pyran (DHP) forming intermediate (2). Intermediate (2) was then hydrolyzed to form a THP-benzoic acid derivative (4). In the second reaction, intermediate (1) was hydrolyzed to generate a hydroxy terminated benzoic acid (3). The hydroxy terminated benzoic acid (3) is contacted with CH₂CH₂COCl in an organic solvent to form a intermediate (5). Tert-butyl dimethylsilyl chloride (TBDMS) was used to protect methyl hydroquinone. The major isomer was isolated by chromatography and then reacted with the THP-benzoic acid derivative (4) forming intermediate (6). This reaction product was then selectively deprotected using tert-butylamonium fluoride (TBAF) in tetrahydrofuran (THF) to form intermediate (7). Intermediate (7) was esterified with intermediate (5) forming ester (8) and the resulting ester was deprotected with AMBERLYST^{R}15 in a mixture of methanol and THF, forming mesogenic group (9). Various components used in this synthesis method may be varied to affect the composition of the resulting diamine without undue experimentation.

Mesogenic group (9) may be contacted with dinitro diphenic acid followed by tin (II) chloride reduction in ethanol to form a diamine of formula I. Such a diamine may be used to prepare a polyimide of the present invention.

Mesogens within the class encompassed by V may be synthesized in the following manner. 4-cyano-4′-hydroxybiphenyl may be contacted with an ω-bromoalkanol in an S_{N}2 reaction in refluxing acetone over 3-4 days. This results in the production of a 4-(ω-hydroxyalkoxy)-4′-cyanobiphenyl compound which may be further purified by recrystalization from ethanol. Alternatively, 4-cyano-4′-hydroxybiphenyl may be contacted with an α,ω alkanediol in a Mitsunobu reaction to form a 4-(ω-hydroxyalkoxy)-4′-cyanobiphenyl compound. The product of the Mitsunobu reaction may be purified by flash chromatography. Mesogens within the class encompassed by IV may be synthesized by similar methods, by starting with a hydroxybiphenyl compound instead of 4-cyano-4′-hydroxybiphenyl.

These mesogens may be used to produce mesogen-containing diamine compounds of formula I by coupling the mesogen with a dinitro diphenic acid using the standard dicyclohexylcarbodiimide (DCC)/DMAP procedure to produce a dinitro intermediate compound. Alternatively, dinitro diphenic acid may be converted to 4,4′-dinitro-2,2′-biphenyl-carbonyl chloride by refluxing with thionyl chloride. The mesogen may be contacted with 4,4′-dinitro-2,2′-biphenyl-carbonyl chloride in an organic solvent such as triethylamine or methylene chloride to produce a dinitro intermediate. The dinitro intermediate may be reduced to form a diamine by stannous chloride reduction or by reduction using hydrazine in an organic solvent at 80° C.

Mesogens of the present invention may also be coupled to brominated biphenylcarboxylic acids to produced brominated diamines of formula I. Cyanuric acid is contacted with bromine and the resulting compound is used to brominate 4,4′-dinitro-2,2′-biphenyl-carboxylic acid yielding 6,6′-dibromo-2,2′-biphenylcarboxylic acid. This brominated carboxylic acid may be coupled with a mesogen and reduced as described above to produce a brominated diamine.

Diamines of formula II may be synthesized by the following technique. 3,5-dinitrobenzoic acid is esterified with n-octadecanol to afford n-octadecyl 3,5-dinitrobenzoate using DCC as a dehydration agent in dichloroethane. The dinitrobenzoate is reduced to n-octadecyl 3,5-diaminobenzoate using hydrazine as a reducing agent. By substituting other alcohols for n-octadecanol, the value of x in formula II may be varied.

Diamines of the present invention may be purified by chromatography on deactivated silica gel and subsequent recrystalization. Purified diamines may then be contacted with acid dianhydrides to produce polyimides. The synthesis of polyimides is known in the art. See for example, “Synthesis and Characterization of Aromatic Polyesters and Polyimides Containing Mesogenic Pendent Groups,” PhD dissertation of Shyh-Yeu Wang, The University of Akron, December, 1995, the disclosure of which is herein incorporated by reference. Briefly summarized, polyimide precursors may be synthesized from dianhydrides and diamines by either a 2-step or a 1-step method. In the 2-step method, a soluble polyimide precursor, i.e., a polyamic acid, is prepared by the reaction of dianhydrate and diamine in a polar aprotic solvent at room temperature. The polyimide precursor is cyclodehydrated to form the corresponding polyimide either by thermal or chemical methods. The 2-step method gives high molecular weight polyimides if the diamine is highly reactive. However, when the diamine contains electron withdrawing groups such as CF₃, CN and NO₂, for example, the reactivity of the diamine is reduced and low molecular weight products result. When such electron withdrawing groups are present, the 1-step method is preferred. In the 1-step method, polymerization is carried out by heating the dianhydride and diamine at 180°-220° C. in high boiling solvents, such as m-cresol and p-chlorophenol for example, in the presence of a tertiary amine catalyst. Under these conditions, polymerization and imidization occur essentially simultaneously. The water generated from imidization is continuously removed, such as by distillation for example.

It has surprisingly been found that the pre-tilt angle of the alignment layer may be altered by varying the composition of various substituents of mesogen-containing polyimides. For example, the linking group R₁ in formulas I and II greatly influences the pre-tilt angle generated by the resulting polyimide. When R₁ is an ester group the resulting polyimide has a greater pre-tilt angle than when R₁ is an ether group. It has also been determined that a cyano-substituted biphenyl mesogenic group (formula V, for example) gives a polyimide that exhibits a slightly higher pre-tilt angle than a polyimide containing a non-substituted biphenyl mesogenic group (formula IV).

An alignment layer material made from the polyimide of the present invention provides a high pre-tilt angle. In one embodiment, the alignment layer provides a pre-tilt angle between about 50 and about 90°. Preferably, the alignment layer provides a pre-tilt angle between about 100 and about 800. More preferably, the polyimide layer provides a pre-tilt angle between about 200 and about 800. In one particular example, the polyimide layer provides a pre-tilt angle between about 40° and about 70°. It will be appreciated that the pre-tilt angle described herein relates to the use of one single alignment layer with one single liquid crystal layer and not a plurality of layers to obtain the above mentioned angles. A greater thickness of liquid crystal material is not required.

It has also been determined that the dianhydride used to synthesize a mesogen-containing polyimide also affects the pre-tilt angle. For example, the dianhydride 2,2′-bis-(3,4-dicarboxyphenyl)-1,1,1,3,3,3-hexafluoropropane dianhydride (6FDA) provides a polyimide with a greater pre-tile angle than a similar polyimide based on 3,3′,4,4′-biphenyltetracarboxylic dianhydride (BPDA). The present invention is not limited to the dianhydrides 6FDA and BPDA. Any acid dianhydride suitable for generating traditional polyimides for alignment layers may also be used in the polyimide of the present invention. Among other acceptable acid dianhydrides are 2,2′-bis[4-(3,4 dicarboxyphenoxy)phenyl]propane dianhydride (BisA-DA), pyromellitic diahydride (PMDA), dibromo-biphenyltetracarboxylic dianhydride, 3,6-diphenylpyromellitic dianhydride, 3,6-bis(trifluoromethyl)pyromellitic dianhydride, 3,6-bis(methyl) pyromellitic dianhydride, 3,6-diidopyromellitic dianhydride, 3,6-dibromopyromellitic dianhydride, 3,6-dichloropyromellitic dianhydride, 3,3′,4,4′-benzophenonetetracarboxylic acid dianhydride, 2,3,3′,4′-benzophenonetetracarboxylic acid dianhydride, 2,2′,3,3′-benzophenone tetracarboxylic acid dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)propane dianhydride, bis(3,4-dicarboxyphenyl)ether dianhydride (4,4′-oxydiphthalic anhydride), bis(3,4-dicarboxyphenyl)sulfone dianhydride, (3,3′,4,4′-diphenylsulfonetetracarboxylic dianhydride), 4,4′-[4,4′-isopropylidene-di(p-phenyleneoxy)]bis(phthalic anhydride), N,N-(3,4-dicarboxyphenyl)-N-methylamine dianhydride, bis(3,4-dicarboxyphenyl)diethylsilane dianhydride; naphthalene tetracarboxylic acid dianhydrides such as 2,3,6,7- and 1,2,5,6-naphthalene-tetracarboxylic acid dianhydride, 2,6-dichloronaphthalene-1,4,5,8-tetracarboxylic acid dianhydride; or heterocyclic aromatic tetracarboxylic acid dianhydrides such as thiophene-2,3,4,5-tetracarboxylic acid dianhydride, pyrazine-2,3,5,6-tetracarboxylic acid dianhydride and pyridine-2,3,5,6-tetracarboxylic acid dianhydride.

Substituents in the diamine component other than the mesogenic group also affect the pre-tilt angle of the resulting polyimide. When a diamine component contains only mesogenic substituents, a polyimide with a greater pre-tilt angle results compared to similar polyimides containing a diamine component which contain bromine substituents as well as mesogenic substituents.

The pre-tilt angle of a polyimide can also be varied by co-polymerization of a mixture of diamines with a dianhydride. In such an example, a diamine containing pendent mesogen groups may be mixed with a diamine containing perfluorinated carbon atoms and polymerized with a diamine such as 6FDA.

Finally, it has been found that increasing the length of a methylene spacer gives a higher pre-tilt angle at lower heat treatment temperatures. The pre-tilt angle yielded by such polyimide used as an alignment layer, however, decreases rapidly as the heat treatment temperatures increase.

In order to demonstrate the practice of the present invention, polyimides containing pendant mesogen groups contributed by a diamine were synthesized and tested for the pre-tilt angle they produced. In the following examples one or more diamines and an acid dianhydride were polymerized in refluxing m-cresol, 1-chloronapthalene or o-dichlorobenzene containing isoquinoline at 180-200° C. A nitrogen purge was used to remove the water. The polymers were isolated by precipitation in methanol and dried under reduced pressure at about 200° C. for 6-8 hours. The resulting polyimides were dissolved in an organic solvent such as cyclopentanone and N-methylpyrrolidone (NMP) at 1.5 weight percent and filtered through 1.0 μm filters. Alignment layers were formed by spin coating on an indium-tin oxide (ITO) glass substrate at 2,000 rpm. The layers were heat treated at 150° C., 200° C., 225° C., or 250° C. before mechanical rubbing. The rubbing was carried out on a LCBM4 liquid crystal buffing machine. Liquid crystal displays were then constructed via a standard procedure. ZLI2293 liquid crystal molecules (available from Merck) were added to the cells at room temperature. The pretilt angles provided by the polyimides were determined by either the crystal rotating method or the magnetic null method. The composition of the various polyimides tested, an abbreviation of each polyimide, the pre-tilt angle provided by each polyimide and comments regarding the observed uniformity of the alignment layer are summarized in Tables 1-4. A prior art polyimide (6FDA-PFMB) is also included in Table 1 for comparison purposes. Pre-tilt angles after heat treatment at 225° C. are listed in Table 1. In Table 2, pre-tilt angles were measured after heat treatment at 250° C., except as noted otherwise. In Table 3, pre-tilt angles were measured after heat treatment at 200° C., except as noted otherwise, and pre-tilt angles after heat treatment at 150° C. are listed in Table 4.

TABLE 1

| | | Pretilt | |
|---|---|---|---|
| Chemical Structure | Abbreviation | Angle | Comments |
| 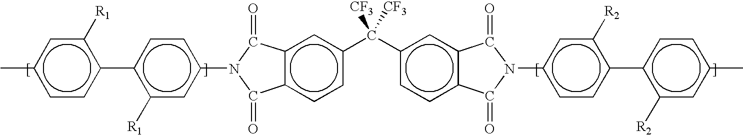 | 6FDA/C6CN/C18x(90/10) | 39° | uniform |
| 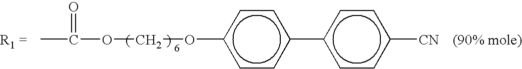 | | | |
| 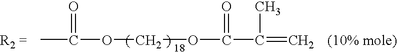 | | | |
| 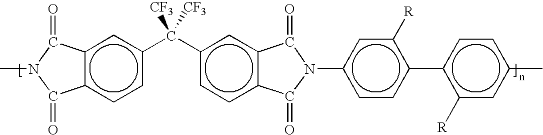 | 6FDA/C6CN | 42° | uniform |
| 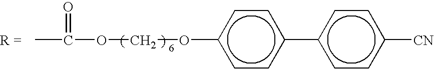 | | | |
| 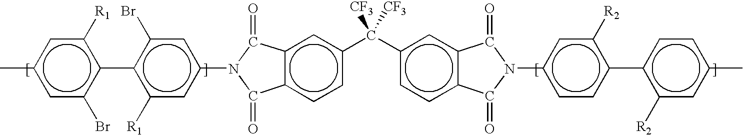 | 6FDA/BrC6CN/LCx(90/10) | 45° | uniform |
| 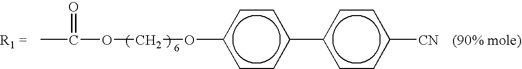 | | | |
| 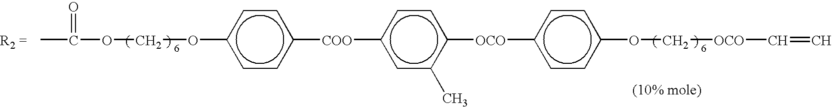 | | | |
| 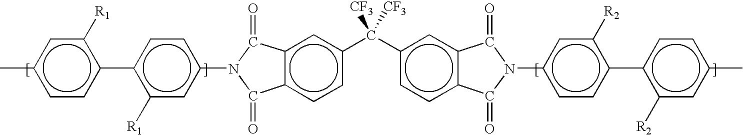 | 6FDA/C6BP/LCx(90/10) | 18° | uniform |
| 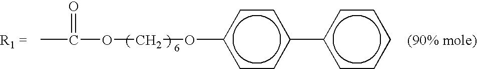 | | | |
| 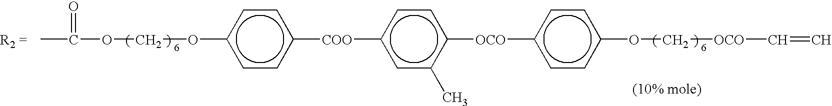 | | | |
| 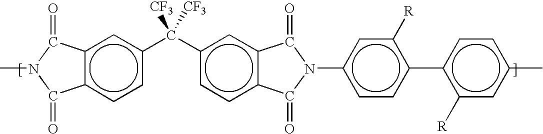 | 6FDA/C6CN(ether) | 20° | uniform |
| 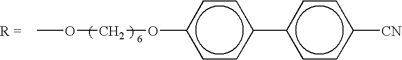 | | | |
| 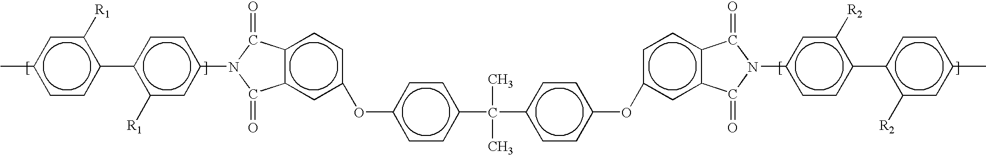 | BisADA/F8C10/MC18x(90:10) | 10° | uniform |
| 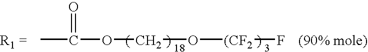 | | | |
| 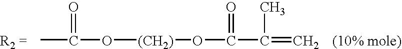 | | | |
| 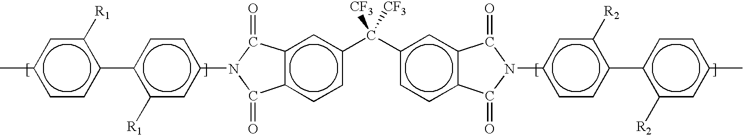 | 6FDA/C6BP/MC18X(90:10) | 19° | uniform |
| 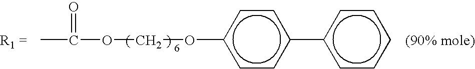 | | | |
| 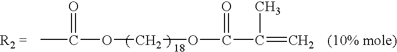 | | | |
| 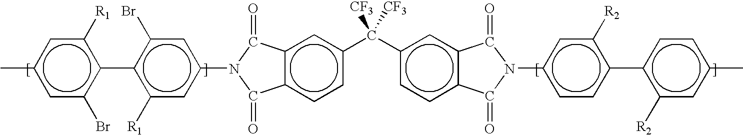 | 6FDA/BrC6CN/MC18x(90:10) | 24° | not uniform |
| 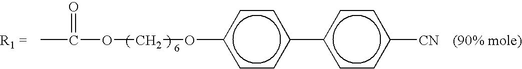 | | | |
| 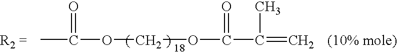 | | | |
| 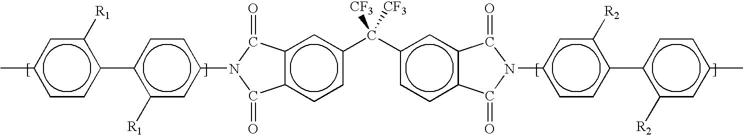 | 6FDA-PFMB/MC18x(90:10) | 3° | uniform |
| R₁ = —CF₃ (90% mole) | | | |
| 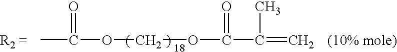 | | | |
| 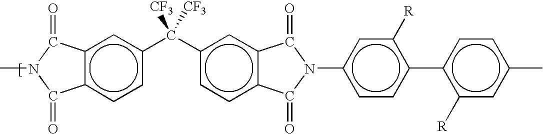 | 6FDA/C6BP | 40° | uniform |
| 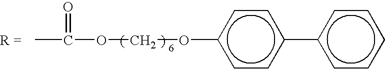 | | | |
| 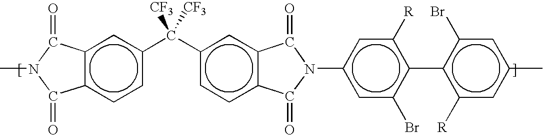 | 6FDA/BrC6CN | 20° | uniform |
| 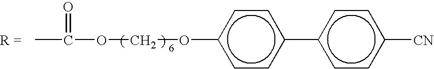 | | | |
| 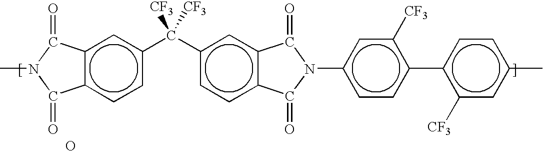 | 6FDA/PFMB | 1.5° | uniform |
| 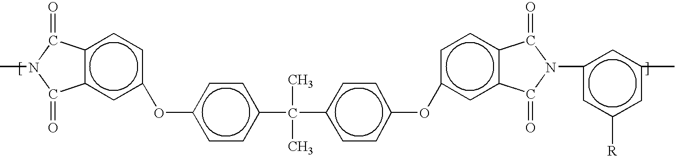 | BisADA/bentC6CN | 4.5° | uniform |
| 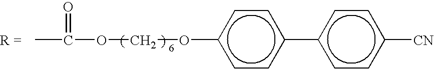 | | | |
| 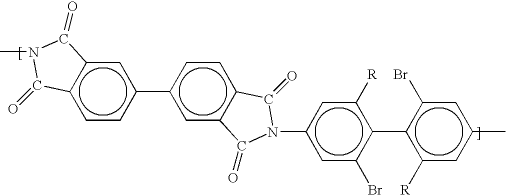 | BPDA/BrC6CN | 1.5° | uniform |
| 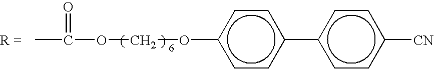 | | | |
| 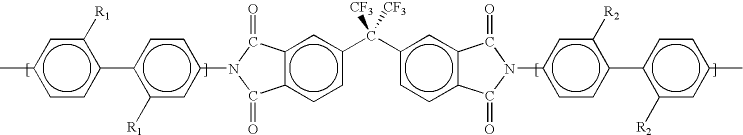 | 6FDA/C6CN/PFMB(1:3) | 10° | uniform |
| R₁ = —CF₃ (75% mole) | | | |
| 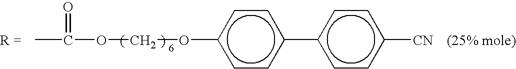 | | | |
| 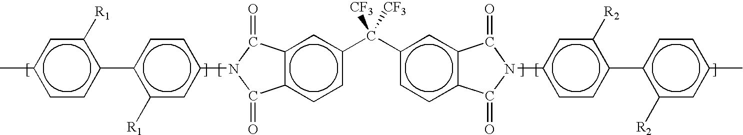 | 6FDA/C6BP/PFMB(1:3) | 7° | uniform |
| R₁ = —CF₃ (75% mole) | | | |
| 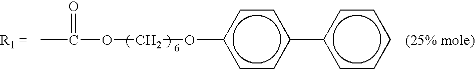 | | | |
| 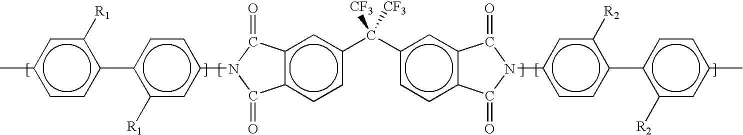 | 6FDA/C11CN/PFMB(1:3) | 13° | uniform |
| R₁ = —CF₃ (75% mole) | | | |
| 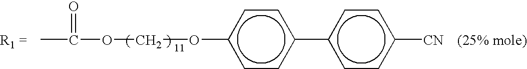 | | | |

TABLE 2

| | | Pretilt | |
|---|---|---|---|
| Chemical Structure | Abbreviation | Angle | Comments |
| 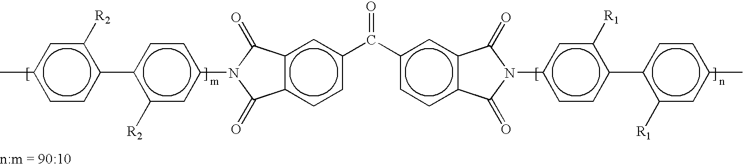 | BTDA/C18/LCx(90/10) | 21.5° | uniform |
| 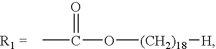 | | | |
| 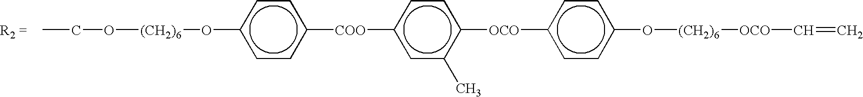 | | | |
| 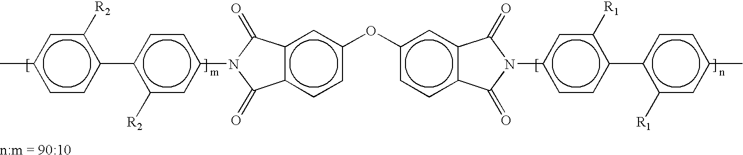 | OPDA/C18/LCx(90/10) | 10.0° | uniform |
| 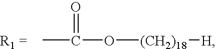 | | Homeo- tropic^{a} | |
| 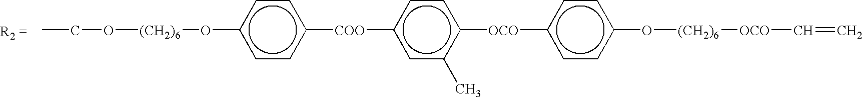 | | | |
| 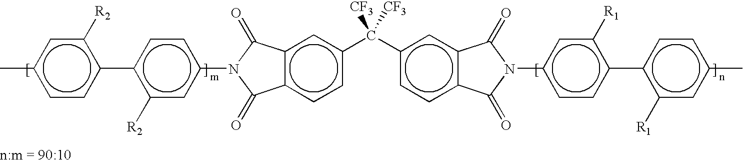 | 6FDA/C18/LCx(90/10) | 18.5° | uniform |
| 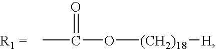 | | ˜90°^{a} | |
| 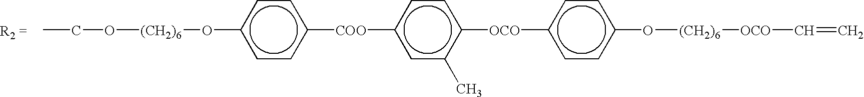 | | | |
| 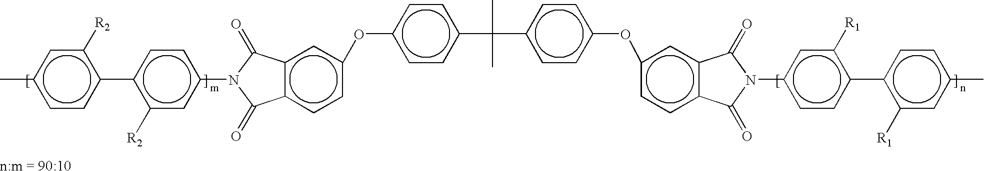 | BisADA/C18/LCx(90/10) | — | not very uniform |
| 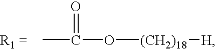 | | ˜90°^{a} | uniform |
| 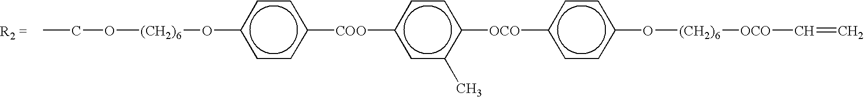 | | | |
| 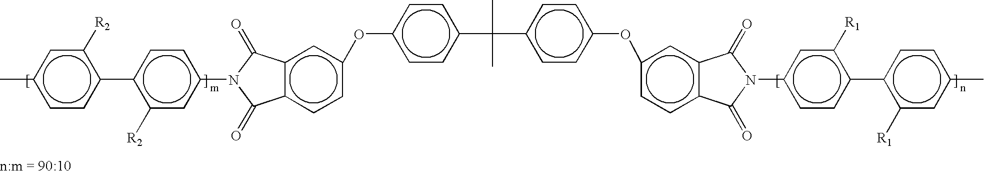 | BisADA/C18/C18x(95/5) | — | polydomain |
| 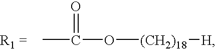 | | | |
| 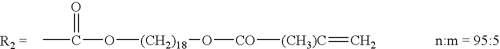 | | | |
| 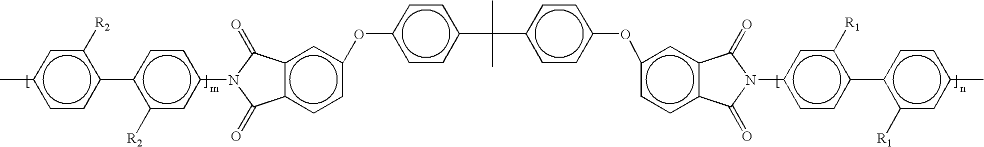 | BisADA/C18/C18x(80/20) | 20.5° | not very uniform |
| 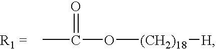 | | | |
| 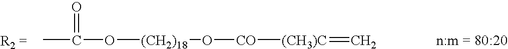 | | | |
| 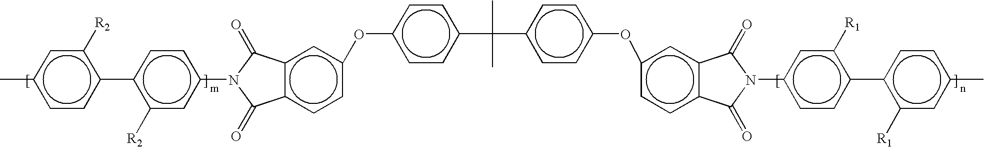 | BisADA/C18/C18x(90/10) | 25.5° | uniform |
| 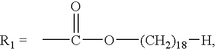 | | | |
| 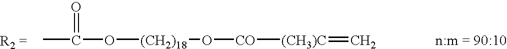 | | | |
| 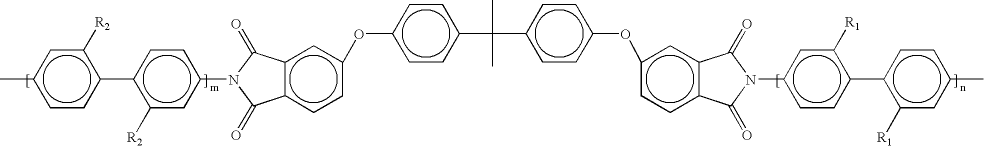 | BisADA/C18/C18x(85/15) | 12.0° | uniform |
| 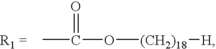 | | | |
| 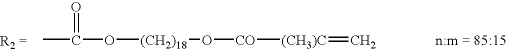 | | | |

^{a}curing at 150° C.

TABLE 3

| | | Pretilt | |
|---|---|---|---|
| Chemical Structure | Abbreviation | Angle | Comments |
| 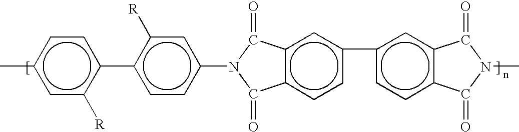 | BPDA/C11CN | — | not soluble in NMP, cyclopentanone, TCE |
| 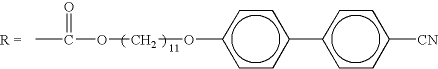 | | | |
| 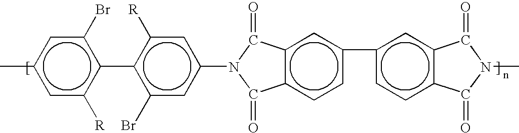 | BPDA/BrC6CN | 15° | soluble in NMP |
| 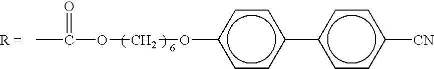 | | | |
| 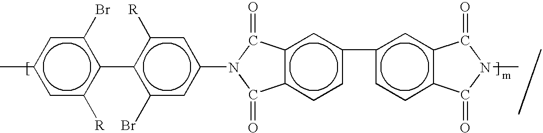 | BPDA/BrC11CN/PFMB(1:2) | 20° | uniform |
| 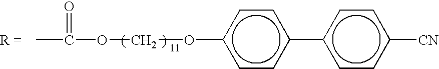 | | | |
| 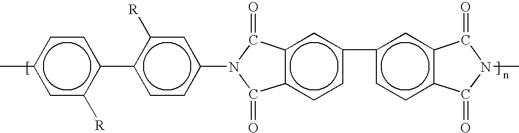 | | | |
| R = —CF₃ | | | |
| 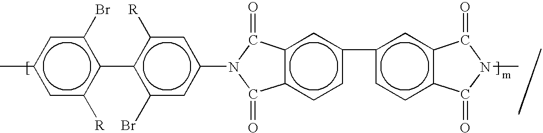 | BPDA/BrC6CN/PFMB(1:2) | 6-7° | uniform |
| 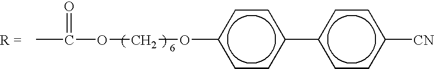 | | | |
| 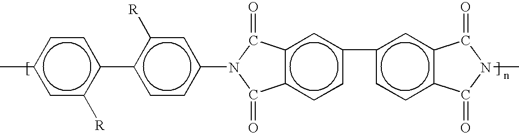 | | | |
| R = —CF₃ | | | |
| 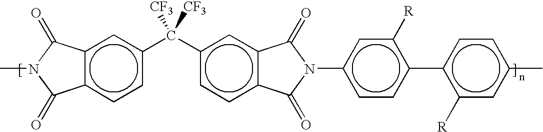 | 6FDA/C6CN/C18x(90/10) | 54° | uniform |
| 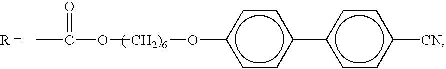 | | ˜90°^{a} | |
| 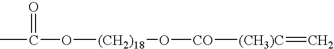 | | | |
| 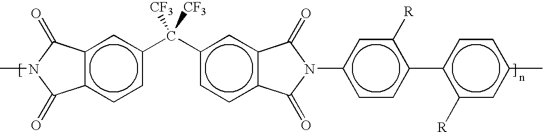 | 6FDA/C6CN/C18x(95/5) | 55° | uniform |
| 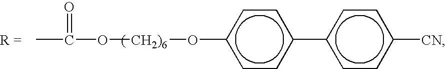 | | 41°^{a} | |
| 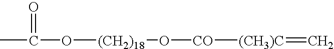 | | | |
| 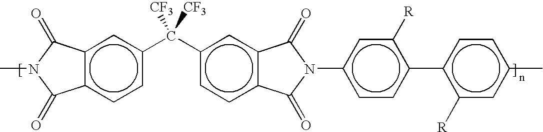 | 6FDA-C6CN | 45° | uniform |
| 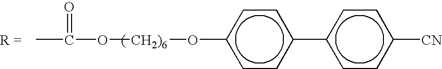 | | 38°^{a} | |
| 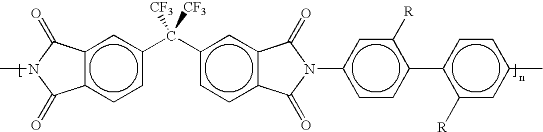 | 6FDA-C11CN | 40° | uniform |
| 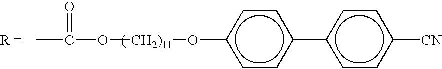 | | ˜90°^{a} | |
| 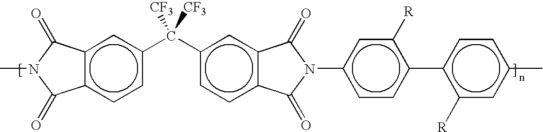 | 6FDA-C6OCN | 18.5° | uniform |
| 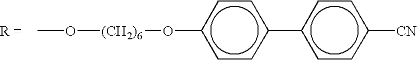 | | | |
| 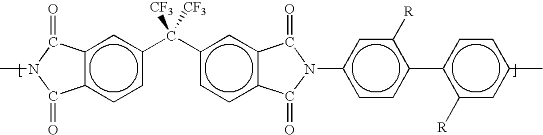 | 6FDA-C6BIPHENYL | 38° | uniform |
| 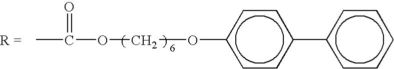 | | | |
| 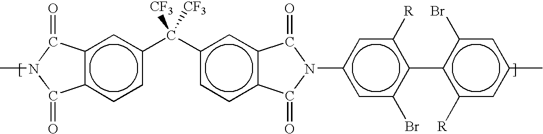 | 6FDA-BrC6CN | 34° | uniform |
| 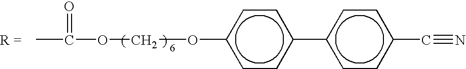 | | | |
| 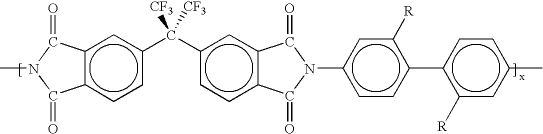 | 6FDA-C6CN/PFMB(1:3) | 7-8° | uniform |
| 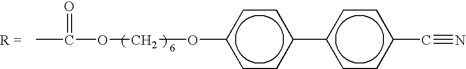 | | | |
| 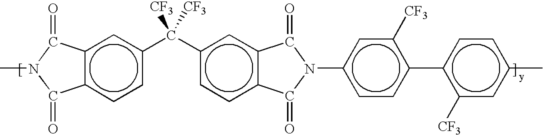 | | | |

^{a}curing at 150° C.

TABLE 4

| Chemical Structure | Abbreviation | Pretilt Angle | Comments |
|---|---|---|---|
| 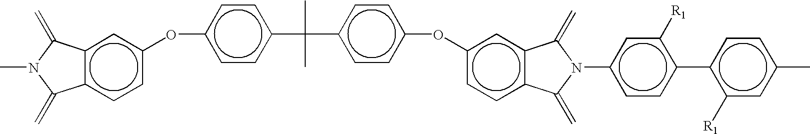 | BisADA-C11CN | ˜90° | uniform |
| 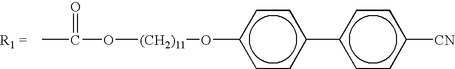 | | | |
| 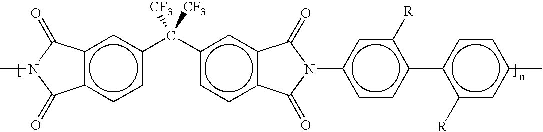 | 6FDA/PFMB/C6BP(1:1) | 15.0° | not very uniform |
| 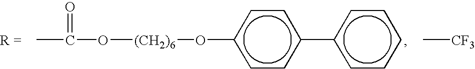 | | | |
| 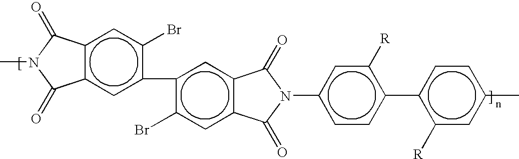 | DBBPDA-C6CN | 18.5° | not uniform, due to the flow effect |
| 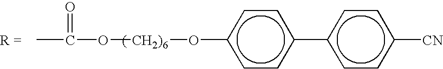 | | | |
| 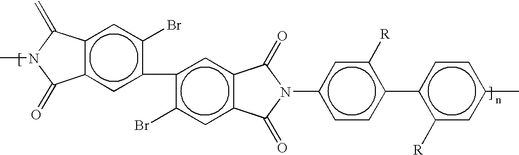 | DBBPDA-C6OCN | 40.0° | not uniform, due to the flow effect |
| 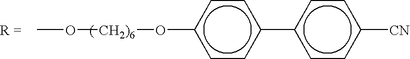 | | | |
| 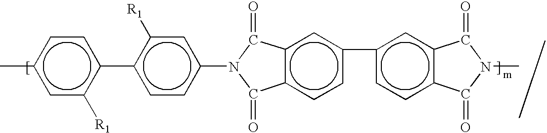 | BPDA/C16/PFMB(1:2) | 25.0° | uniform |
| 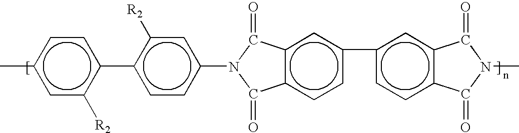 | | | |
| 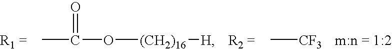 | | | |
| 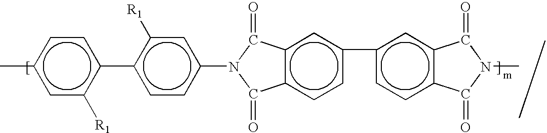 | BPDA/C16/PFMB(1:1) | 22.0° | uniform |
| 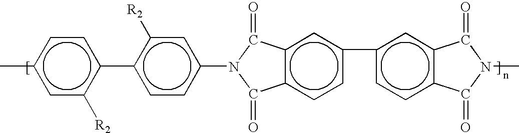 | | | |
| 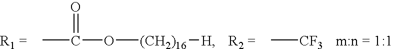 | | | |
| 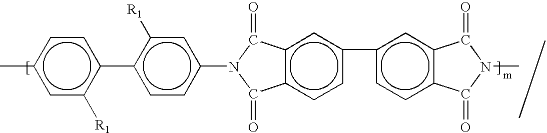 | BPDA/C18Br/C16(1:1) | 29.0° | uniform |
| 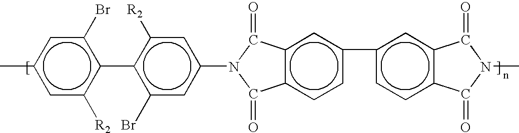 | | | |
| 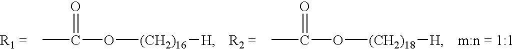 | | | |
| 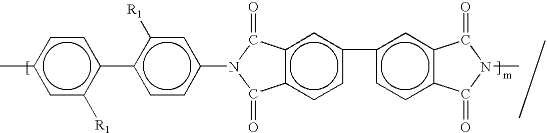 | BPDA/C16/PFMB(1:2) | 25.0° | uniform |
| 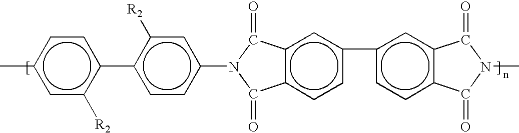 | | | |
| 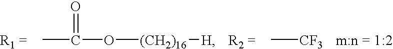 | | | |
| 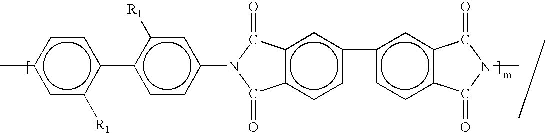 | BPDA/C16/PFMB(1:1) | 22.0° | uniform |
| 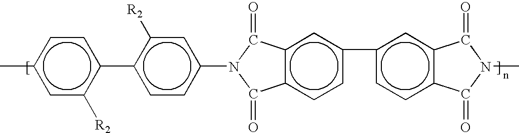 | | | |
| 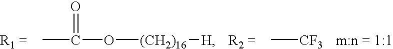 | | | |
| 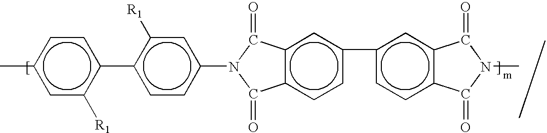 | BPDA/C16/C18Br(1:1) | 29.0° | uniform |
| 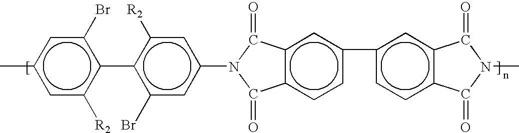 | | | |
| 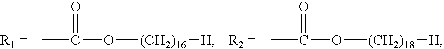 | | | |

As mentioned above and as indicated by the data in Table 1, a number of different factors affect the pre-tilt angle provided by the polyimide of the present invention. The type of linkage between the mesogen and the aromatic portion of the diamine is one such factor. For example, 6FDA/C6CN provides a pre-tilt angle of 42°, while 6FDA/C6CN(ether) provides a pre-tilt angle of 200. These polyimides differ from each other only in the type of linkage between the mesogen and the aromatic group. It is apparent, therefore that the ester linkage of 6FDA/C6CN provides a greater pre-tilt angle than the ether linkage of 6FDA/C6CN(ether).

As also shown in Table 1, the use of a cyano-substituted mesogen gives a polyimide which provides a slightly higher pre-tilt angle than a non-substituted mesogen. For example, the pre-tilt angle provided by 6FDA/C6CN is greater than the pre-tilt angle provided by 6FDA-C6Biph. These compounds differ only in the substitution of the biphenyl portion of the mesogens of each polyimide.

The dianhydride used in the polyimides of the present invention also affect the pre-tilt angle. For example, 6-FDA provides a greater pre-tilt angle than BPDA when linked to BrC6CN. 6FDA-BrC6CN provides a pre-tilt angle of 20°, while BPDA-BrC6CN provides a pre-tilt angle of 1.50.

Substituents in the diamine component other than the mesogenic group also affect the pre-tilt angle of the resulting polyimide. A diamine component that contains only mesogenic substituents, such as 6FDA/C6CN, provides a polyimide with a greater pre-tilt angle than a similar polyimide such as 6FDA-BrC6CN, which contains a diamine component having bromine substituents as well as mesogenic substituents. The pre-tilt angle of 6FDA/C6CN is 42°, while the pre-tilt angle of 6FDA-BrC6CN is 20°. These polyimides differ only in the presence of bromine substituents on the diamine portion of 6FDA-BrC6CN.

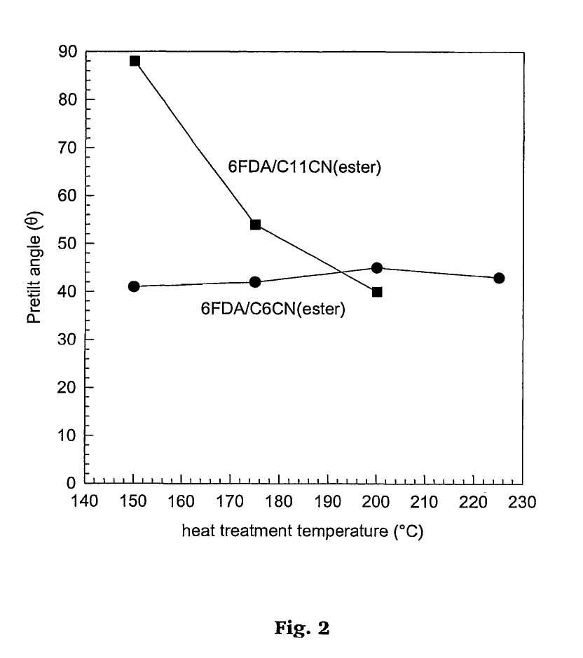

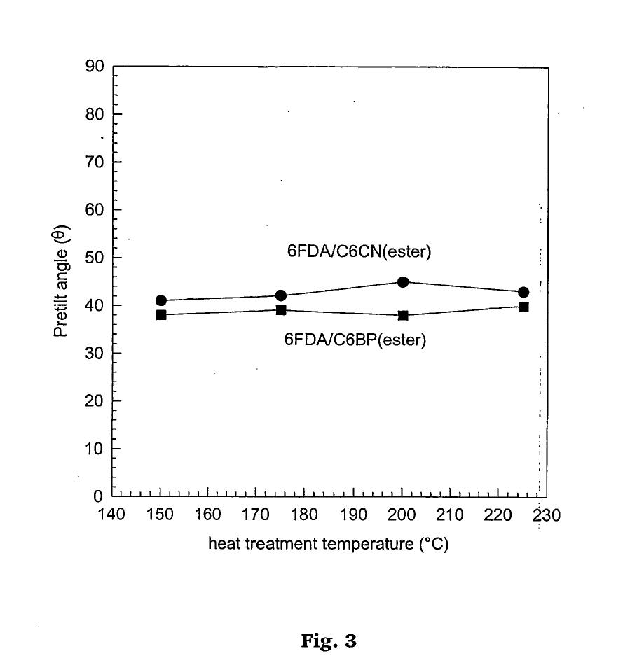

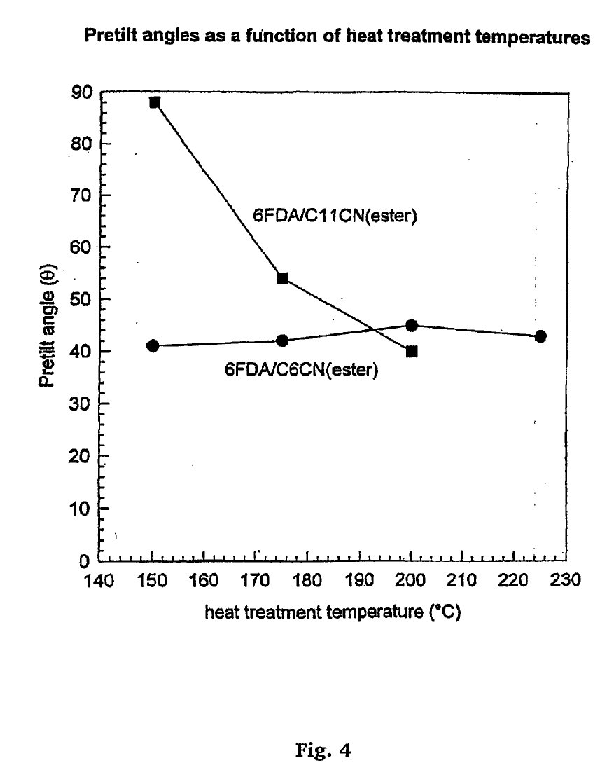

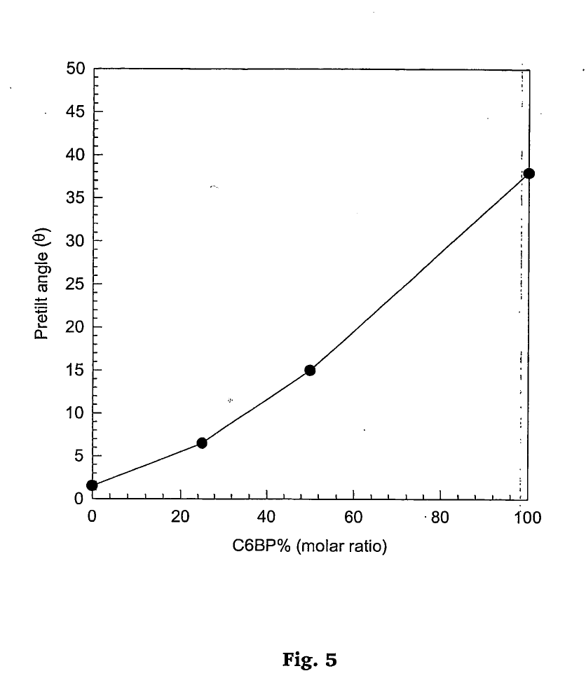

As the data in Table 1-4 indicate, heat treatment temperature influences the pre-tilt angle provided by the polyimide. The pre-tilt angles of 6FDA/C6CN and 6FDA/C6CN(ether) after heat treatment at 150° C., 175° C., 200° C., and 225° C. are compared graphically in FIG. 2. The pre-tilt angles of 6FDA/C6CN and 6FDA/C6BP are compared in FIG. 3 and the pre-tilt angles of 6FDA/C6CN and 6FDA/C11CN are compared in FIG. 4 after similar heat treatments. The pre-tilt angles provided by 6FDA/C6CN, 6FDA/G6CN(ether), and 6FDA/C6BP are relatively similar over the heat treatment temperatures tested as shown in Tables 1 and 2. The pre-tilt angle provided by 6FDA/C11CN, however decreases as the heat treatment temperature increases, as seen in FIG. 5. The pre-tilt angle provided by 6FDA/C11CN is about 90° at a heat treatment temperature of 150° C. At a heat treatment temperature of 200°, the pre-tilt angle drops to about 400.

A mixture of diamines may also be used to synthesize a polyimide for use as an alignment layer. By altering the composition of the polyimide, the pre-tilt angle can be varied. FIG. 5 is a graph showing the pre-tilt angles of polyimides containing diamines with mesogenic pendent groups (C6BP), diamines with perfluorinated carbon pendent groups (PFMB), or mixtures thereof. FIG. 5 illustrates that the pre-tilt angle provided by a polyimide obtaining its diamine component only from PFMB is 1.50. The pre-tilt angle of a polyimide obtaining its diamine component from a mixture of PFMB and C6BP increases as the percentage of C6BP increases relative to PFMB. When the polyimide is solely C6BP-based, the pre-tilt angle increases to about 40°.

Based upon the foregoing disclosure, it should now be apparent that the polyimide alignment layers of the present invention will carry out the objects set forth hereinabove. It is, therefore, to be understood that any variations evident fall within the scope of the claimed invention and thus, the selection of specific component elements can be determined without departing from the spirit of the invention herein disclosed and described.

We claim:

1. A polyimide comprising a reaction product of:
at least one dianhydride and
at least one diamine, wherein the at least one diamine contains a pendent mesogenic group,
with the proviso that when the at least one dianhydride is 2,2′-bis-(3,4-dicarboxyphenyl)-1,1,1,3,3,3-hexafluoropropane dianhydride or dibromo-biphenyltetracarboxylic dianhydride, the at least one diamine is not 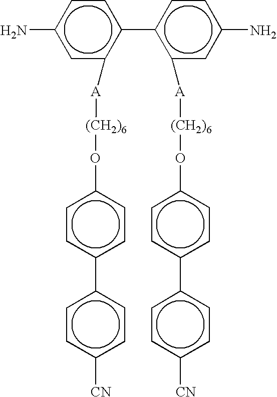
wherein A is selected from the group consisting of O and COO.

2. The polyimide of claim 1, wherein the at least one diamine comprises:
a backbone portion, a methylene spacer, a linking group, and a pendent mesogenic group, and wherein the pendent mesogenic group is attached to the methylene spacer, the methylene spacer is attached to the linking group, and the linking group is attached to the backbone portion, and wherein linking group is selected from the group consisting of an ester and an ether.

3. The polyimide of claim 1, wherein the at least one diamine is selected from the group consisting of compounds represented by formulas I and II, 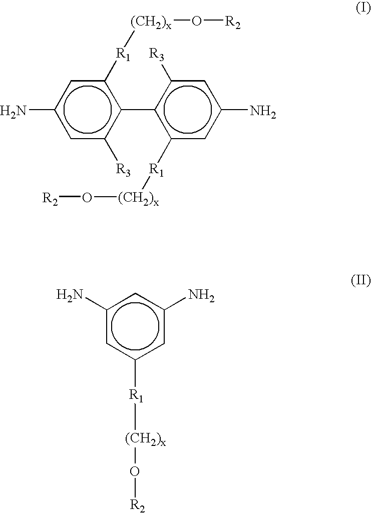
wherein R₁ is selected from the group consisting of an ester and an ether, R₂ is a mesogenic group, R₃ is selected from the group consisting of hydrogen and halogens, and x is a positive number.

4. The polyimide of claim 3, wherein x is an integer between 6 and 18.

5. The polyimide of claim 3, wherein x is 6.

6. The polyimide of claim 3, wherein R₃ is bromine.

7. The polyimide of claim 1, additionally comprising a functional group.

8. The polyimide of claim 1, wherein the diamine contains a substituent selected from the group consisting of compounds containing one or more of the subunits represented by formulas III, IV, V, and VI, 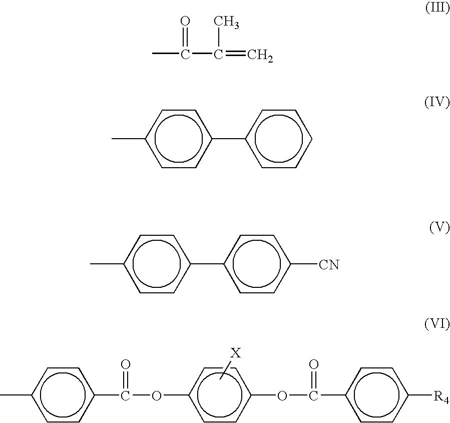
wherein R₄ is selected from the group consisting of an ester, an ether, a methylene group, a vinyl group and combinations thereof, and X is selected from the group consisting of hydrogen and an organic group having from 1 to 20 carbon atoms, with the proviso that when the at least one dianhydride is 2,2′-bis-(3,4-dicarboxyphenyl)-1,1,1,3,3,3-hexafluoropropane dianhydride or dibromo-biphenyltetracarboxylic dianhydride, the substituent is not represented by formula V.

9. The polyimide of claim 1, wherein the polyimide is an alignment layer material for a liquid crystal device.

10. The polyimide of claim 9, wherein the alignment layer provides a pre-tilt angle of at least about 20° in a single layer.

11. The polyimide of claim 9, wherein the alignment layer material provides a pre-tilt angle of greater than or equal to about 39° in a single layer.

12. The polyimide of claim 9, wherein the alignment layer material provides a pre-tilt angle of greater than about 40° in a single layer.

13. The polyimide of claim 1, wherein the polyimide is an alignment layer material for a LC display optical compensator.

14. A method for inducing a predetermined orientation of a liquid crystal material comprising:
applying an alignment layer material to a substrate; and
buffing the alignment layer material, thereby providing an alignment layer with a pre-tilt angle, wherein the alignment layer material is a reaction product of at least one dianhydride and at least one diamine, and wherein the at least one diamine contains a pendent mesogenic group.

15. The method of claim 14, wherein the at least one diamine comprises:
a backbone portion, a methylene spacer, a linking group, and a pendent mesogenic group, and wherein the pendent mesogenic group is attached to the methylene spacer, the methylene spacer is attached to the linking group, and the linking group is attached to the backbone portion, and wherein linking group is selected from the group consisting of an ester and an ether.

16. The method of claim 14, wherein the at least one diamine is selected from the group consisting of compounds represented by formulas I and II, 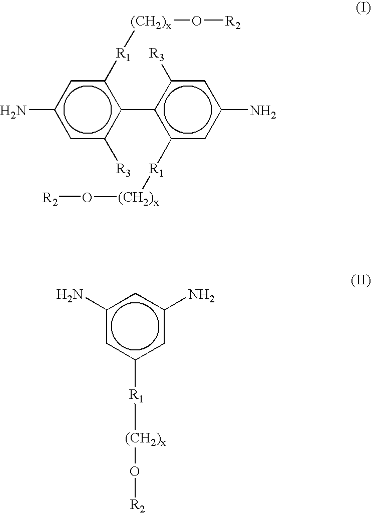
wherein R₁ is selected from the group consisting of an ester and an ether, R₂ is a mesogenic group, R₃ is selected from the group consisting of hydrogen and halogens, and x is a positive integer.

17. The method of claim 16, wherein x is an integer between 6 and 18.

18. The method of claim 14, wherein the at least one diamine contains a substituent selected from the group consisting of compounds containing one or more of the subunits represented by formulas III, IV, V, and VI, 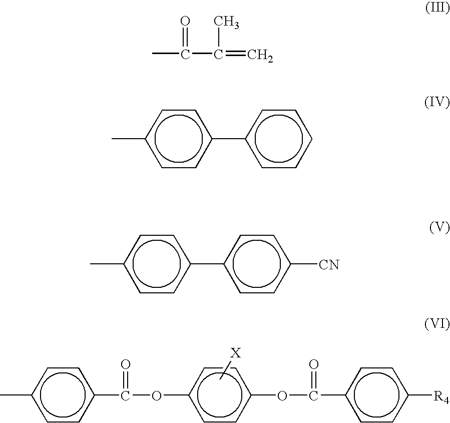
wherein R₄ is selected from the group consisting of an ester, an ether, a methylene group, a vinyl group and combinations thereof, and X is selected from the group consisting of hydrogen and an organic group having from 1 to 20 carbon atoms, with the proviso that when the at least one dianhydride is 2,2′-bis-(3,4-dicarboxyphenyl)-1,1,1,3,3,3-hexafluoropropane dianhydride or dibromo-biphenyltetracarboxylic dianhydride, the substituent is not represented by formula V.

19. The method of claim 14, wherein the pre-tilt angle provided by a single layer of alignment layer material is greater than about 200.

20. The method of claim 14, wherein the pre-tilt angle provided by a single layer of alignment layer material is greater than or equal to about 39°.
